(19) United States
(12) Patent Application Publication
(10) Pub. No.: US 2013/0201374 A1
(43) Pub. Date: Aug. 8, 2013

(54) CAMERA FOR RECORDING AERIAL IMAGES FROM AIRCRAFT

(71) Applicants: Martin Timm, Aalen (DE); Martin Welzenbach, Aalen (DE); Holger Stoldt, Eindhoven (NL); Jörn Hildebrandt, Jena (DE); Dirk Döring, Erfurt (DE)

(72) Inventors: Martin Timm, Aalen (DE); Martin Welzenbach, Aalen (DE); Holger Stoldt, Eindhoven (NL); Jörn Hildebrandt, Jena (DE); Dirk Döring, Erfurt (DE)

(73) Assignee: HEXAGON TECHNOLOGY CENTER GMBH, Heerbrugg (CH)

(21) Appl. No.: 13/696,197

(22) PCT Filed: May 5, 2011
(86) PCT No.: PCT/EP2011/057185

§ 371 Date: Apr. 22, 2013

(30) Foreign Application Priority Data
May 6, 2010 (DE) 10 2010 019 805.6

(51) Int. Cl. H04N 5/225

(52) U.S. Cl. CPC H04N 5/2251
USPC 348/302

(57) ABSTRACT

A camera, more particularly for recording aerial images from aircraft, comprising a lens and at least one digital, areal image sensor fixed on a carrier element and having a predetermined pixel size, which image sensor has a curvature, more particularly caused by the fixing on the carrier element within a specific tolerance range. The lens at least partly brings about optical compensation of the curvature of the digital areal image sensor.

The invention relates to a camera, more particularly for recording aerial images from aircraft, having a lens and, affixed on a substrate, at least one digital two-dimensional image sensor, with a predetermined pixel dimension, having arching within a specific tolerance range, said arching in particular being due to the attachment on the substrate.

Practical experience has taught that digital image sensors, in particular CCD (charge coupled device) image sensors, should as a result of commercial demands or for reasons of cost have ever finer pixel geometries or smaller pixel dimensions in the case of unchanging dimensions or utilized amounts of silicon. By way of example, very large CCD sensors with more than 140 megapixels are already in production. This results in pixel dimensions of less than 7.2 μm, more particularly e.g. 5.6 μm. These requirements also increase the requirements in respect of the focused imaging of the light within the pixel geometries at a given depth of field.

There now is a problem inasmuch as the silicon plate of the CCD sensor generally needs to be applied, usually by adhesive bonding, to a substrate, e.g. a housing or the like. Adhesives exert a greater adhesive force at the corners of the silicon plate because the silicon material is pulled by two force vectors. As a result, the silicon plate obtains measurable arching.

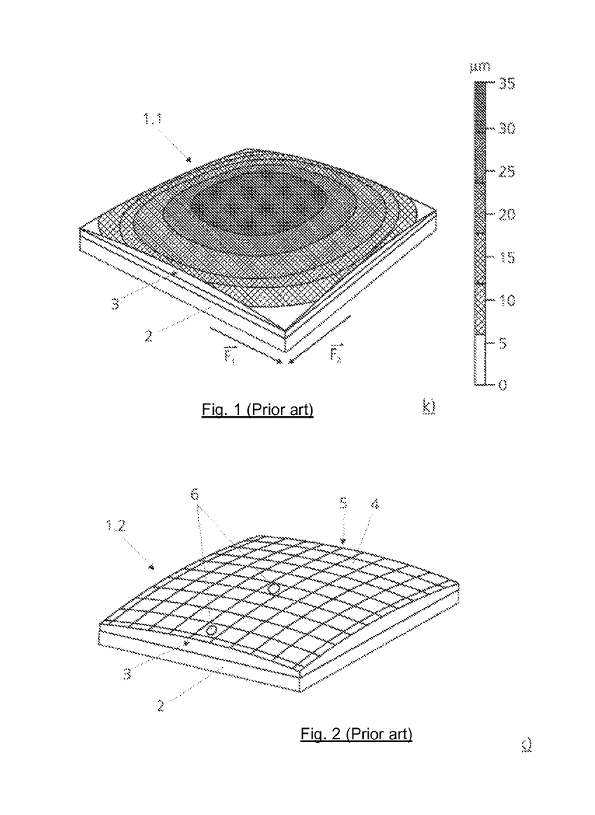

FIG. 1 illustrates a digital two-dimensional image sensor of silicon or CCD sensor 1.1 with arching 3 of up to 35 μm. The different heights of the CCD sensor 1.1 are indicated by different shading in accordance with the scale illustrated to the right of the image sensor 1.1 in FIG. 1. If the corner regions of the CCD sensor 1.1 are considered to be zeros, there is arching 3 of up to 35 μm in the center of the CCD sensor 1.1. This arching emerges as a result of force vectors \vec{F}₁, \vec{F}₂ when adhesively bonding the CCD sensor 1.1 onto a substrate 2, which may be formed from glass, ceramics or plastic.

FIG. 2 illustrates a CCD sensor 1.2, which is likewise adhesively bonded onto the substrate 2.

During the production process—for as long as the silicon plate or the CCD sensor 1.2 has not yet been adhesively bonded and therefore does not yet have arching 3—the individual pixels can be considered to be small, at least rectangular or even square light-sensitive regions 4, which are arranged on the surface of the silicon plate or of the CCD sensor 1.2 as a grid 5. In FIG. 2, the depth of field is sufficient if a conventional lens is used for the whole arching 3 to be covered such that the light is imaged in focus in the individual light-sensitive regions 4, as a result of which there is no influence on the image quality. This is the case if the pixel dimension is large enough and, as illustrated in FIG. 2 in a much simplified fashion, the light points 6 are imaged in focus as individual light rays within the light-sensitive regions 4.

FIG. 3 illustrates a further CCD sensor 1.3, which is adhesively bonded onto the substrate 2 and in which the dimensions of the light-sensitive regions 4′ are so small that the depth of field is no longer sufficient for imaging in focus within the whole arching 3. That is to say that individual light points 6′ are no longer imaged in focus and light also reaches the surrounding or adjacent light-sensitive regions 4′, the result of which being an adverse effect on the image quality, particularly in respect of resolution and contrast.

However, a good image quality should be ensured if such CCD sensors 1.1 to 1.3 are used in cameras, more particularly for recording aerial images from aircraft, even in the case of relatively small pixel dimensions and relatively large CCD sensors 1.1 to 1.3.

Proceeding therefrom, the object of the present invention is to avoid the disadvantages of the prior art, in particular to develop a camera of the type mentioned at the outset, in which a sufficient image quality is ensured even in the case of small pixel dimensions and large image sensors.

According to the invention, this object is achieved by a camera, more particularly for recording aerial images from aircraft, having a lens with, affixed on a substrate, at least one digital two-dimensional image sensor, with a predetermined pixel dimension, having arching within a specific tolerance range, said arching in particular being due to the attachment on the substrate, wherein the lens brings about at least partial optical compensation of the arching of the digital two-dimensional image sensor.

As a result of the measures according to the invention, the arching, and hence the reduced image quality accompanying this, is advantageously compensated for optically, particularly in the case of relatively small pixel dimensions. This is brought about by the lens or the design of the optical unit. To this end, a tolerance range for the arching of the digital two-dimensional image sensor should be prescribed during the production in order to be able to define the optical unit accordingly. This tolerance range should be kept as constant as possible during the production process.

Accordingly, it is very advantageous if the observation light rays or the light are/is, as a result of the compensation, at least approximately imaged in focus within the pixel dimension or the pixel geometry of the digital planar two-dimensional image sensor.

The optical imaging properties of the lens can be established in advance on the basis of a predetermined model related to a specific tolerance range of the arching of the digital two-dimensional image sensor.

For compensating the arching, at least one optical element of the lens can bring about an appropriate image distortion.

A digital two-dimensional image sensor can be adhesively bonded onto the substrate and preferably have a pixel dimension of less than or equal to 7.2 μm, more particularly of 5.6 μm. Here, there is a connection between the pixel dimension, the imaging-point dimension of the lens and the curvature of the digital two-dimensional image sensor. The pixel dimensions are therefore not set absolutely.

The digital two-dimensional image sensor or frame sensor can be embodied as CCD sensor, CMOS sensor or the like. The pixels of the digital two-dimensional image sensor can be arranged in the form of a rectangular matrix.

The substrate can comprise glass, ceramics or plastic, or be made therefrom.

Claim 9 specifies a photogrammetric camera system having a plurality of cameras.

Advantageous embodiments and developments of the invention emerge from the dependent claims.

In the following text, the drawing will be used to describe the principles of an exemplary embodiment of the invention.

In detail:

FIG. 1 shows a perspective view of a digital two-dimensional image sensor according to the prior art, adhesively bonded to a substrate;

FIG. 2 shows a perspective view of an adhesively bonded CCD sensor with a first pixel dimension according to the prior art;

FIG. 3 shows a perspective view of an adhesively bonded CCD image sensor with a second pixel dimension according to the prior art;

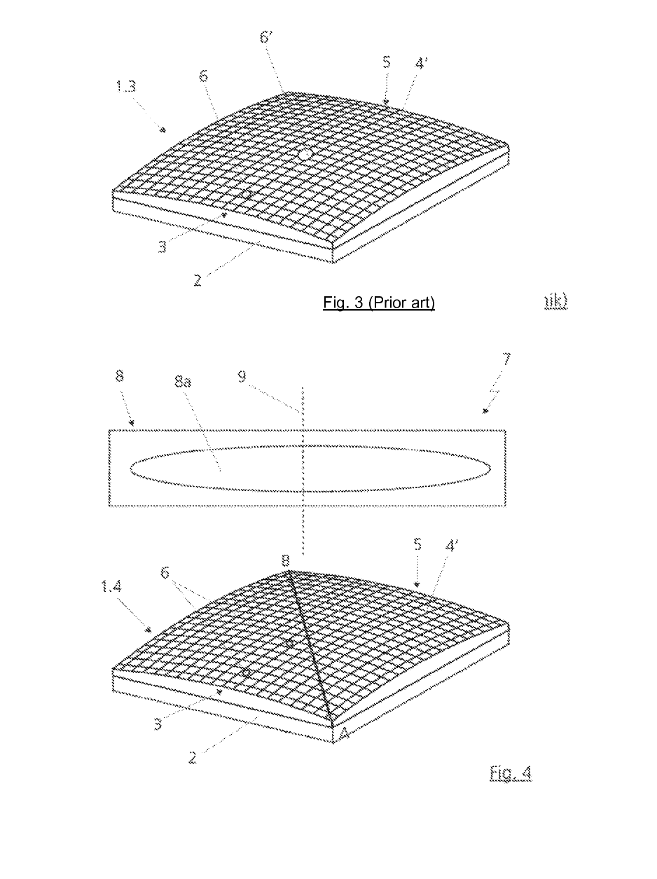

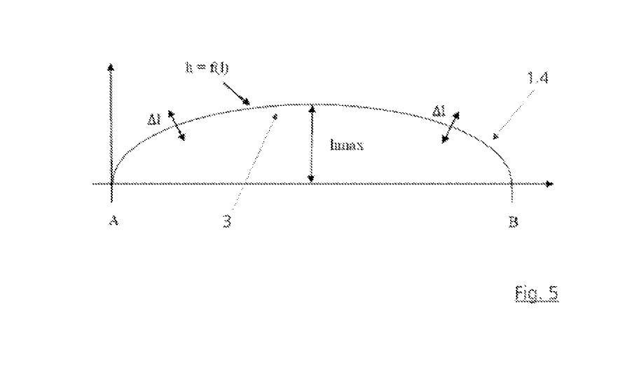

FIG. 4 shows a much simplified illustration of a camera according to the invention; and

FIG. 5 shows a simplified sectional illustration of a CCD image sensor of the camera according to the invention from FIG. 4.

FIG. 4 illustrates a camera 7 according to the invention, more particularly for recording aerial images from aircraft (not illustrated), having a lens 8 and, affixed on a substrate 2, a digital two-dimensional image sensor or CCD sensor 1.4 with a predetermined pixel dimension or predetermined pixel regions 4′, which sensor has arching 3 within a specific tolerance range as a result of the attachment to the substrate 2. The lens 8 at least in part brings about an optical compensation of the arching 3 of the CCD sensor 1.4. The pixels or light points 6 of the observation light rays, indicated by the dashed line 9, are imaged at least approximately in focus within the light-sensitive regions or pixel regions 4′ as a result of the compensation. In order to compensate the arching 3, an optical element 8a of lens 8 brings about an appropriate image distortion.

The CCD image sensor 1.4 is adhesively bonded to the substrate 2. In the present exemplary embodiment, the CCD image sensor 1.4 has a pixel dimension of less than or equal to 7.2 μm, more particularly of 5.6 μm. The substrate 2 can be made of glass, ceramics or plastic, or comprise such materials.

The camera 7 can be one of a plurality of cameras of a photogrammetric camera system.

The optical imaging properties of the lens 8 are established in advance on the basis of a predetermined model. To this end, the surface of each CCD sensor 1.4 is measured. The optical imaging properties of the lens 8 are matched to the CCD image sensor 1.4 on the basis of the surface measurement. Moreover, a generic tolerance range Δ1 is specified, within which the CCD image sensor 1.4 is constant during mass production. The model is related to the specific tolerance range Δ1 of the arching 3 of the CCD image sensor 1.4. For clarification purposes, FIG. 5 illustrates a section along the line A-B through the CCD image sensor 1.4 from FIG. 4. The use of the model function h=f(1) and the definition of the maximum height hmax of the CCD image sensor 1.4 and of the tolerance range Δ1 render it possible to match the optical imaging properties of the lens 8 to the CCD image sensor 1.4. The tolerance range Δ1 compensates production tolerances and changes in the surrounding conditions. In the process, the optical unit design or the optical imaging properties of the lens 8 should ensure that the light points 6 remain within the light-sensitive regions or pixel regions 4′ when the surface or the arching of the CCD image sensor 1.4 changes within the tolerance range Δ1.

1-9. (canceled)

10. A camera comprising a lens and, affixed on a substrate, at least one digital two-dimensional image sensor, with a predetermined pixel dimension, having arching within a specific tolerance range, wherein the lens brings about at least partial optical compensation of the arching of the digital two-dimensional image sensor.

11. The camera as claimed in claim 10, wherein said arching is due to the attachment on the substrate.

12. The camera as claimed in claim 10, wherein the camera is designed for recording aerial images from aircraft

13. The camera as claimed in claim 10, wherein the observation light rays are, as a result of the compensation, at least approximately imaged in focus within the pixel dimension of the digital two-dimensional image sensor.

14. The camera as claimed in claim 10, wherein the optical imaging properties of the lens are established in advance on the basis of a predetermined model related to the specific tolerance range of the arching of the digital two-dimensional image sensor.

15. The camera as claimed in claim 10, wherein, for compensating the arching, at least one optical element of the lens brings about an appropriate image distortion.

16. The camera as claimed in claim 10, wherein the digital two-dimensional image sensor is adhesively bonded onto the substrate.

17. The camera as claimed in claim 10, wherein the digital two-dimensional image sensor has a pixel dimension of less than or equal to 7.2 82 m.

18. The camera as claimed in claim 10, wherein the digital two-dimensional image sensor is embodied as CCD sensor or CMOS sensor.

19. The camera as claimed in claim 10, wherein the substrate comprises glass, ceramics or plastic.

20. A photogrammetric camera system having a plurality of cameras, wherein at least one of the cameras is a camera as claimed in claim 10.
